(19) United States
(12) Patent Application Publication
(10) Pub. No.: US 2004/0039849 A1
(43) Pub. Date: Feb. 26, 2004

(54) LAN and IP address setting method reducing user's workload

(75) Inventor: Satoshi Oura, Fukushima-ken (JP)

Correspondence Address: Brinks Hofer Gilson & Lione, P.O. Box 10395, Chicago, IL, 60610, US

(73) Assignee: Alps Electric Co., Ltd.

(21) Appl. No.: 10/639,743

(22) Filed: Aug. 11, 2003

(30) Foreign Application Priority Data
Aug. 23, 2002 (JP) 2002-243695

(51) Int. Cl. G06F 3/00

(52) U.S. Cl. 710/1

(57) ABSTRACT

The application open area in a non-volatile memory of a radio LAN card is used, and a manager, for example, sets an IP address in the area in advance by using a manager PC. Then, the user sets a radio LAN card having the setting of the IP address in the PC to be used by the user. Thus, the IP address set in the radio LAN card can be automatically set in the PC. Therefore, according to the invention, for the communication among the PCs, the workload for a user to set an IP address in the PC used by the user can be reduced.

### BACKGROUND OF THE INVENTION

1. Field of the Invention

The present invention relates to a LAN and an IP address setting method and, in particular, to an IP address setting method for a LAN including multiple machines such as PCs using LAN cards and machines such as PC.

2. Description of the Related Art

Generally, multiple machines such as PCs having radio LAN card are participated in a conventional LAN, such as a radio LAN. Each of the PCs functions as a network device, and an IP address is set in the PC. The IP address is managed for each network device by a higher-level PC or WS together with a MAC address of and inherent to the radio LAN card. PCs contained in the radio LAN as described above can communicate with each other by using the IP addresses.

In order for PCs included in a conventional LAN as described above to communicate with each other by using the IP addresses, respective users using the PCs must set the IP addresses in the PCs. An IP address may be set dynamically by using DHCP protocol for dynamically assigning the IP address. The DHCP protocol is included in TCP/IP. Alternatively, an IP address may be set statically by setting the IP address assigned from a network manager to the user.

Generally, for a LAN used within a company, the static IP address setting method is used from a security viewpoint. In this case, a user must spend a great deal of time for the IP address setting, which is a problem.

### SUMMARY OF THE INVENTION

Accordingly, it is an object of the invention to provide a LAN and an IP address setting method, which allow the reduction of a workload of a user to set an IP address.

In order to achieve the object, according to one aspect of the invention, there is provided a LAN for communication among multiple machines each having a communication function. In this case, a LAN card for implementing the communication function can be set in each of the multiple machines in the LAN. An IP address is stored in advance in an application open area of a non-volatile memory within the LAN card. When the LAN card storing the IP address is set in each of the multiple machines, the IP address within the LAN card is set in the machine. The IP address is used for communication.

According to another aspect of the invention, there is provided a method for setting an IP address in each of multiple machines included in a LAN, in which a LAN card can be set in each of the multiple machines in the LAN, the method including the steps of storing an IP address in an application open area of a non-volatile memory within the LAN card by using a manager machine, and setting, in the machine, the IP address within the LAN card when the LAN card storing the IP address is set in each of the multiple machines.

As described above, a workload for a user to set an IP address in a PC can be reduced according to the invention.

### BRIEF DESCRIPTION OF THE DRAWINGS

FIG. 1 is a block diagram showing a construction of a radio LAN according to an embodiment of the invention;

FIGS. 2A and 2B are diagrams describing a radio LAN card and contents in a non-volatile memory within the radio LAN card;

FIG. 3 is a flowchart describing a processing operation for setting an IP address within an application open area; and

FIG. 4 is a flowchart describing a processing operation for setting in a PC an IP address set within the application open area.

### DESCRIPTION OF THE PREFERRED EMBODIMENTS

Embodiments of a LAN and an IP address setting method according to the invention will be described in detail below with reference to drawings. In the embodiments of the invention mentioned below, the invention is applied to a radio LAN.

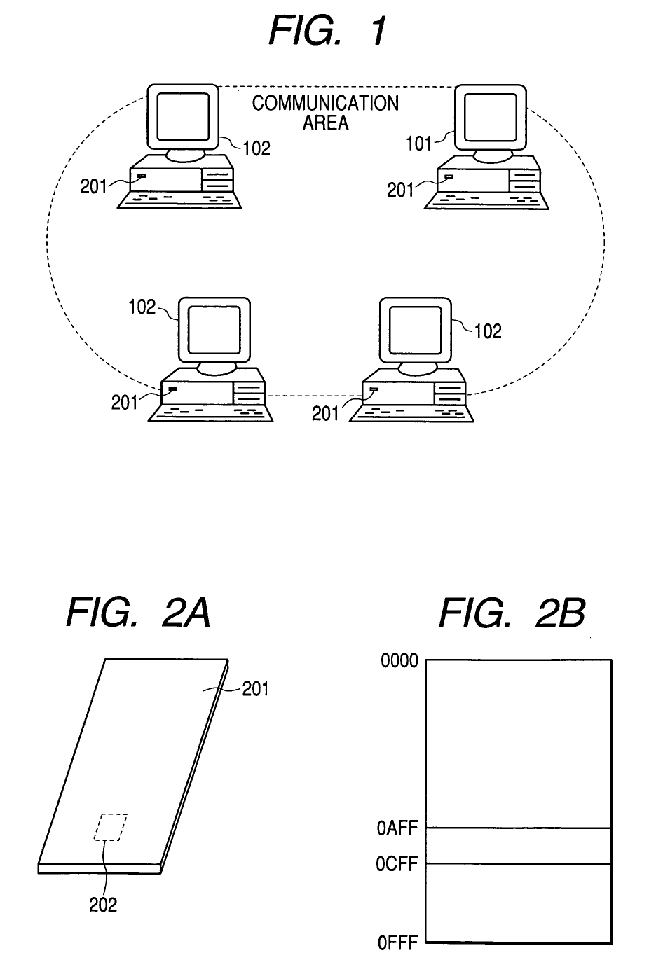

FIG. 1 is a block diagram showing a construction of a radio LAN according to an embodiment of the invention. FIG. 2 is a diagram describing a radio LAN card in a machine such as a PC, which is a network device included in the radio LAN, and contents in a non-volatile memory within the radio LAN card. FIGS. 1 and 2 include a manager PC 101, a PC 102, a radio LAN card 201 and a non-volatile memory 202.

As shown in FIG. 1, the radio LAN according to this embodiment of the invention includes the manager PC 101 having a slot and multiple PC's 102 for communicating with the other PCs within a communication area. The radio LAN card 201 can be set into the slot. Each of the PCs 102 also has a slot in which a radio LAN card 201 can be set. The radio LAN card 201 in one PC has the specification standardized by IEEE Committee and allows the communication with the other PCs within the communication area. Generally, a radio frequency for communication to be used in the radio LAN card 201 is 2.4 GHz or 5 GHz.

As shown in FIG. 2A, the radio LAN card 201 generally has a thin rectangular form. The radio LAN card 201 includes an interface for exchanging information with a PC, a radio transmitter/receiver, a device such as a control portion therefor, and the non-volatile memory 202 storing control data. A PC compliant with the radio LAN card 201 has a card slot. The radio LAN card 201 is set in the card slot for use.

The non-volatile memory 202 stores setting parameter as control data for different kinds of devices in the radio LAN card as described above and the MAC address as described above. As illustrated in FIG. 2B, the memory area of the non-volatile memory includes an application open area, and a user can use the area. For example, as shown in the example in FIG. 2B, the memory area of the non-volatile memory 202 has addresses from “0000” to “0FFF”, the address, “0000” to “0AFF”, are set as the area for storing the setting parameters, which is not accessible by a user. The subsequent addresses to “0CFF” are set as the application open area, which is available to a user.

According to the invention, the application open area in the non-volatile memory 202 of the radio LAN card 201 is used, and a manager sets an IP address in the area in advance by using the manager PC. Then, the user sets a radio LAN card having the setting of the IP address in the PC to be used by the user. Thus, the IP address set in the radio LAN card can be automatically set in the PC. Therefore, according to the invention, for the communication among the PCs 102, the workload for a user to set an IP address in the PC used by the user can be reduced. The manager PC 101 can also participate in the radio LAN and can communicate with the other PCs.

Next, the processing steps for setting, by a manager, for example, an IP address in an application open area in the non-volatile memory 202 of the radio LAN card 201 and processing steps for setting the IP address set in the application open area in the PC will be described.

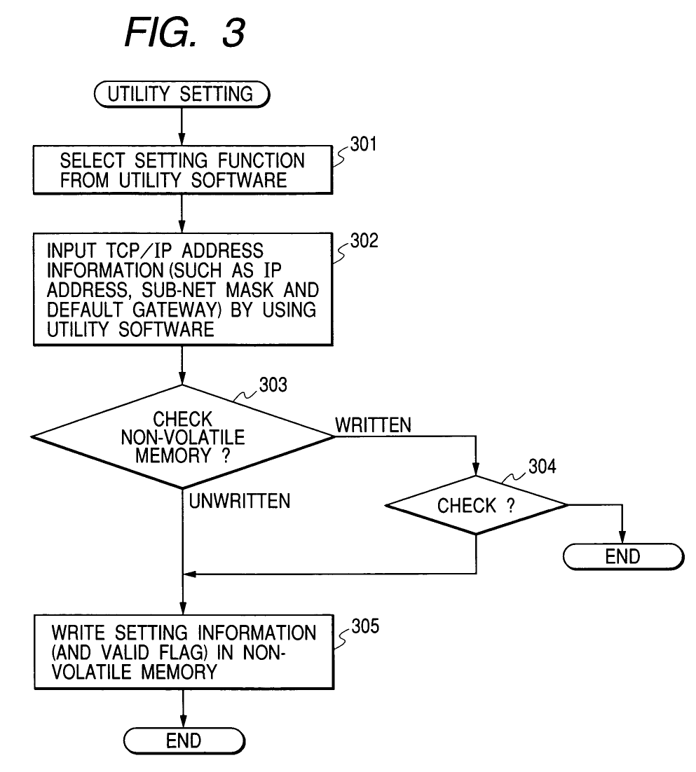

FIG. 3 is a flowchart describing a processing operation for setting an IP address in an application open area. The operation will be described first with reference to FIG. 3. This processing is implemented by a manager, for example, by using the manager PC 101. The utility soft used here is provided together with a radio LAN card and includes a function for setting an IP address in the application open area.

[1] Once the setting processing starts, an operator, such as a manager selects a setting function from the utility software and inputs TCP/IP address information by using the setting function of the utility software. This information includes information on the IP address, sub-net mask and default gateway (steps 301 and 302).

[2] The utility software checks through the application open area in the non-volatile memory 202 and determines whether the information in the area has been written in the area or not (step 303).

[3] If it is determined at the step 303 that the information has been written in the application open area, the fact is informed to the user through the display, for example. If the setting is not necessary, the processing ends here (step 304).

[4] If it is determined at the step 303 that the information has not been written therein, or if it is determined at the step 304 that re-setting is instructed, the TCP/IP address information to be set is written in the application open area in the non-volatile memory 202. Furthermore, a validity flag is set, and the processing ends (step 305).

Through the above-described processing, a user having received the radio LAN card storing the IP address can set the radio LAN card in an arbitrary PC within the communication area and can use the PC for communication.

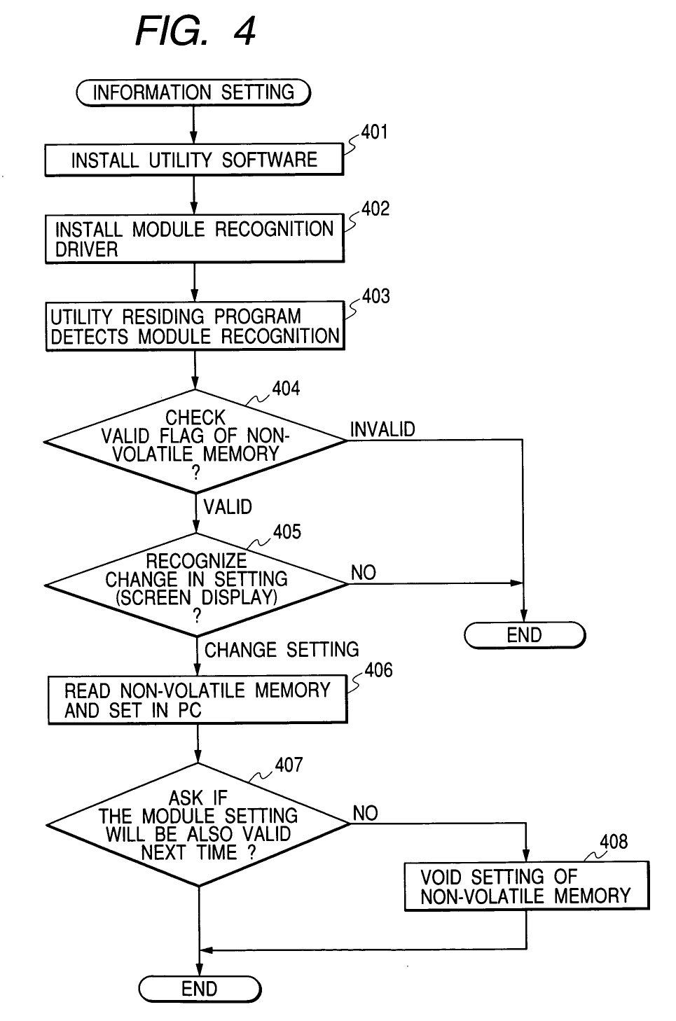

FIG. 4 is a flowchart describing a processing operation for setting, in a PC, an IP address having been set in the application open area described with reference to the flowchart in FIG. 3. Next, this processing operation will be described. A user can implement this processing by using the PC 102, which can be used by a general user. The utility software used here is provided together with a radio LAN card. In this case, the utility software does not have to include a function for setting an IP address in the application open area.

[1] A user sets, in the PC that the user can use, the radio LAN card 201 having the setting of an IP address within the application open area in the non-volatile memory 202 and installs the utility software (step 401).

[2] The utility software recognizes the module as the set radio LAN card and installs the driver. After that, a utility residing program recognizes and detects the module (steps 402 and 403).

[3] The utility software checks the validity flag set in the application open area in the non-volatile memory 202 of the set radio LAN card (step 404).

[4] If it is determined at the step 404 that the validity flag indicates “valid”, a message, for example, is displayed for asking the user whether a new IP address may be set in the PC instead of the IP address having been set in the PC (step 405).

[5] If the user instructs NO at the step 405, and if it is determined at the step 404 that the validity flag indicates “invalid”, nothing is implemented and the processing ends here.

[6] If it is determined at the step 405 that the user instructs OK, the utility software reads the IP address set in the application open area in the non-volatile memory 202 of the radio LAN card and sets the IP address in the PC (step 406).

[7] The utility software asks user whether the setting in the application open area in the non-volatile memory 202 of the set radio LAN card will be also valid next time or not. If the setting will be also valid next time, the processing ends as it is. If the setting will not have to be valid next time, the validity flag is set to invalid. Then, the processing ends (steps 407 and 408).

If the validity flag is set to “invalid” at the step 408, the radio LAN card is set in another PC and cannot be used any more.

The processing according to the embodiment of the invention can be implemented as a processing program, and the processing program can be stored and be provided in a recording medium such as an HD, a DAT, an FD, an MO, a DVD-ROM, and a CD-ROM.

According to this embodiment of the invention, the workload for a user to set an IP address in a PC can be reduced. Furthermore, a user may have a radio LAN card having the setting of his/her IP address and set the radio LAN card in a PC within a communication area. Thus, the PC can be used as his/her PC.

According to this embodiment of the invention, the invention is applied to a radio LAN. However, the invention can be applied to a wired LAN using a LAN card for wired communication.

What is claimed is:

1. A LAN for communication among multiple machines each having a communication function,
wherein a LAN card for implementing the communication function can be set in each of the multiple machines in the LAN;
wherein an IP address is stored in advance in an application open area of a non-volatile memory within the LAN card;
wherein, when the LAN card storing the IP address is set in each of the multiple machines, the IP address within the LAN card is set in the machine;
wherein the IP address is used for communication.

2. A LAN according to claim 1, the IP address is stored in the LAN card by using a manager machine.

3. A method for setting an IP address in each of multiple machines included in a LAN, in which a LAN card can be set in each of the multiple machines in the LAN, the method comprising the steps of:
storing an IP address in an application open area of a non-volatile memory within the LAN card by using a manager machine; and
setting, in the machine, the IP address within the LAN card when the LAN card storing the IP address is set in each of the multiple machines.

4. A utility program in a LAN card, the program comprising:
a processing program for storing input IP address information in an application open area in a nonvolatile memory within the LAN card;
a processing program for reading the IP address from the application open area; and
a processing program for setting the read IP address in the machine in which the LAN card is set.

5. A recording medium storing a utility program according to claim 4.
